(19) United States
(12) Patent Application Publication
(10) Pub. No.: US 2015/0255798 A1
(43) Pub. Date: Sep. 10, 2015

(54) PLATINUM ALLOY NANO CATALYST WITH A NON-PLATINUM CORE

(71) Applicants: UNITED TECHNOLOGIES CORPORATION, Hartford, CT (US); TOYOTA JIDOSHA KABUSHIKI KAISHA, Aichi-ken (JP)

(72) Inventor: Minhua Shao, Farmington, CT (US)

(21) Appl. No.: 14/436,067

(22) PCT Filed: Oct. 22, 2012
(86) PCT No.: PCT/US2012/061286

§ 371 Date: Apr. 15, 2015

(51) Int. Cl. H01M 4/86; H01M 4/92

(52) U.S. Cl. CPC H01M 4/8657; H01M 4/921; H01M 4/926

(57) ABSTRACT

According to one embodiment, a platinum alloy particle includes a core comprising a material that is different from platinum. A shell on the core comprises platinum. The shell has a plurality of facets. At least a majority of the facets are {111} facets.

### TECHNICAL FIELD

The subject matter of this disclosure generally relates to fuel cell components. More particularly, the subject matter of this disclosure relates to catalyst materials useful for fuel cell components.

### BACKGROUND

Fuel cells generate electricity based upon an electrochemical reaction. Typical fuel cell arrangements include a membrane between two electrode layers for facilitating the electrochemical reactions. The electrode layers are often referred to as catalyst layers. One of the catalysts is typically referred to as the anode, while the other is typically referred to as a cathode.

At least the anode layer comprises a material such as platinum, which has proven effective for facilitating the oxidation of fuel, such as hydrogen, to turn the fuel into a positively charged ion and a negatively charged electron. While platinum has proven useful and effective, it is an expensive material.

There has been considerable effort at reducing the cost of fuel cell components. One suggestion has been to replace platinum or to reduce the amount of platinum required, which would reduce the cost of at least one of the electrode layers. A significant challenge associated with attempting to reduce the amount of platinum is that it tends to reduce the activity for facilitating the catalytic reaction.

It has been reported that the {111} facet of the Pt alloys are much more active than {100} and {110} facets (Stamenkovic V R, Fowler B, Mun B S, Wang G, Ross P N, Lucas C A, Markovic N M (2007) Improved oxygen reduction activity on Pt3Ni {111} via increased surface site availability. Science 315:493).

### SUMMARY

According to one example embodiment, a platinum alloy particle includes a core comprising a material that is different from platinum. A shell on the core comprises platinum. The shell has a plurality of facets. At least a majority of the facets are {111} facets.

According to an example embodiment, a fuel cell catalyst component comprises a platinum alloy made up of a core and a shell on the core. The core comprises a material that is different from platinum. The shell comprises platinum. The shell has a plurality of facets. At least a majority of the facets are {111} facets.

The various features and advantages associated with at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an example fuel cell including a catalyst designed according to an embodiment of this invention.

FIG. 2 schematically illustrates an example platinum alloy particle designed according to an embodiment of this invention.

FIG. 3 schematically illustrates a 11111 platinum facet from the example of FIG. 2.

FIG. 4 schematically illustrates an arrangement of platinum atoms in a {111} platinum facet.

### DETAILED DESCRIPTION

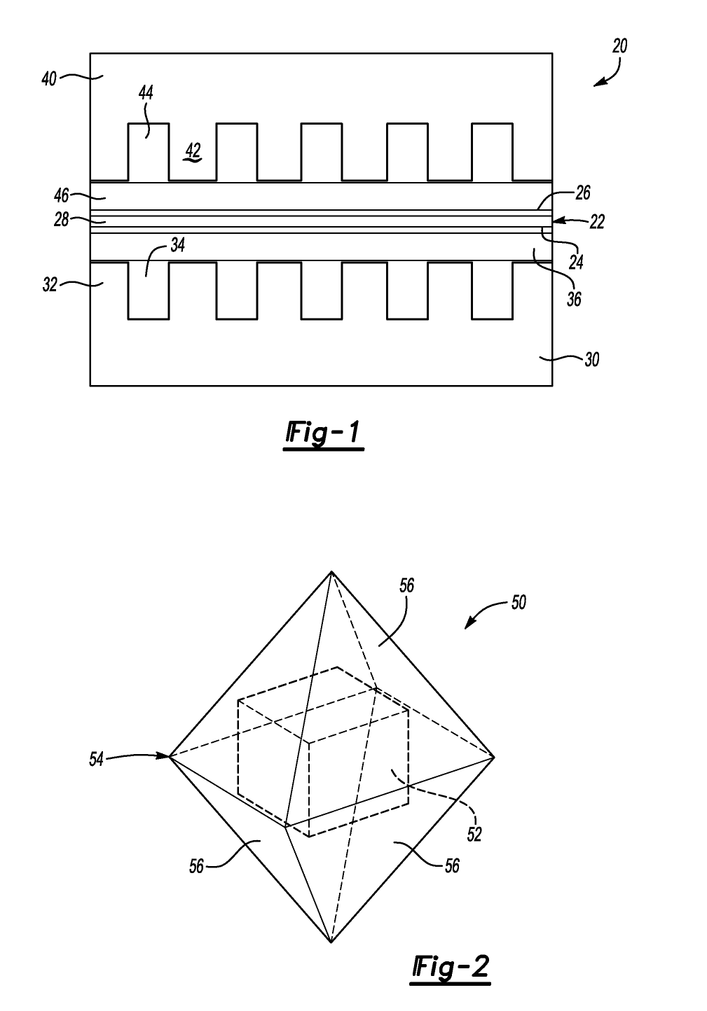

FIG. 1 schematically shows selected portions of a fuel cell 20. A membrane electrode assembly 22 includes catalyst layers 24 and 26 on opposite sides of a membrane 28. For purposes of discussion, the catalyst layer 24 is considered an anode electrode layer and the catalyst layer 26 is considered a cathode electrode layer.

A fluid distribution plate 30 includes a plurality of ribs 32 and channels 34 for delivering a reactant, such as hydrogen, through a gas diffusion layer 36 to the electrode assembly 22. When the reactant, such as hydrogen, reaches the anode electrode catalyst layer 24, hydrogen ions and electrons are separated in a known manner as part of the electrochemical reaction facilitated by the fuel cell 20.

Another fluid distribution plate 40 includes a plurality of ribs 42 and channels 44 for delivering another reactant, such as oxygen, through a gas diffusion layer 46 to the cathode electrode catalyst layer 26.

At least one of the electrode catalyst layers comprise platinum. In this example, a platinum alloy facilitates the catalytic reaction that occurs at the corresponding catalyst layer. As schematically shown in FIG. 2, a platinum alloy particle 50 includes a core 52 and a shell 54 on the core 52. In this example, the shell 54 has the shape of an octahedron having eight sides or facets 56. In another example the shell 54 has a tetrahedral shape.

The core 52 comprises a non-platinum material. In one example, the core 52 comprises palladium. In the illustrated example, the core 52 has a cube shape. Other shapes of the core 52 are possible, such as octahedron, cubo-octahedron, sphere. In another example, the core 52 comprises at least one noble metal, such as Ru, Rh, Pd, Ag, Re, Os, Ir and Au. In another example, the core 52 comprises a metal alloy, such as PdCo. In another example, the core 52 comprises a metal oxide, a carbide or a polymer.

The example shell 54 comprises a platinum alloy including Pt and at least one transition metal, such as Ni, Co, Fe, Cr, V, Mn, Cu, Zn, Ti, Zr, Y, W, Ta. Other Pt alloys comprise Pt and at least one other noble metal, such as Ru, Rh, Pd, Ag, Re, Os, Ir, Au. In another example, the shell 54 comprises platinum.

Using a core 52 of a non-platinum material provides a less expensive core. At the same time, the example particle 50 has a shell 54 with a high activity. The core 52 serves as a seed for platinum-based shell growth.

A majority of the facets 56 on the example particle 50 are {111} facets. In one example, the {111} facets comprise a Pt alloy, such as Pt₃Ni. Having a majority of the facets 56 as {111} facets maintains a high activity for catalytic reactions. In some examples, all of the facets 56 are {111} facets. In some examples platinum is used instead of Pt₃Ni; and, in such cases, the {111} facets are platinum {111} facets. Utilizing the core 52 of a non-platinum material facilities reducing the expense associated with achieving such a high activity because less platinum is required.

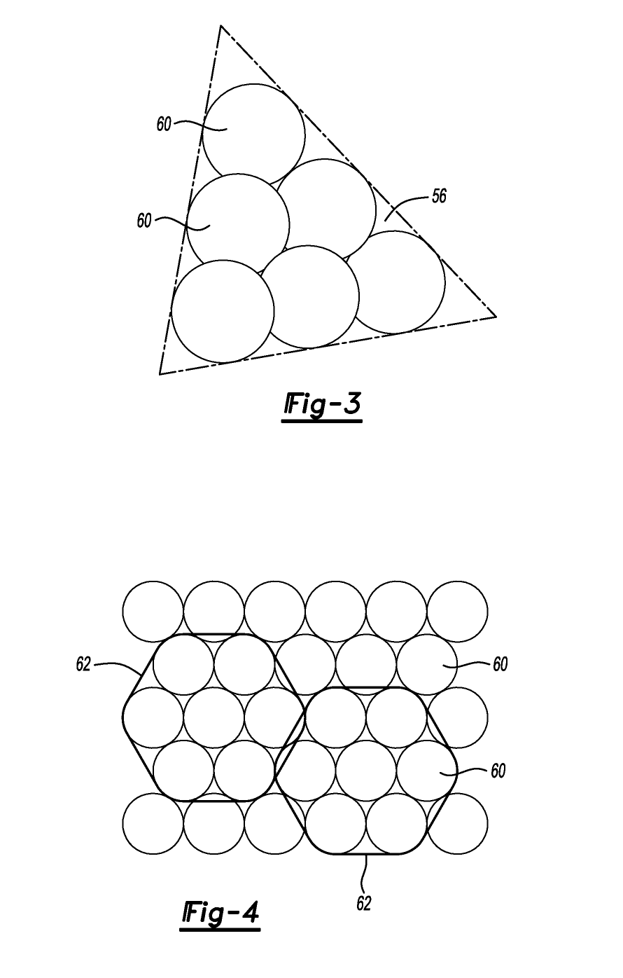

FIG. 3 schematically illustrates an arrangement of platinum atoms 60 on an example facet 56 in a {111} facet arrangement. FIG. 4 schematically illustrates an arrangement of platinum atoms 60 in a hexagonal packaging corresponding to a {111} facet. The hexagonal outlines schematically shown at 62 demonstrate a tight packaging of the platinum atoms 60.

The example catalyst particle 50 provides the ability to achieve the goal of reducing the cost of a fuel cell catalyst without suffering the drawback of having a reduced activity for the catalytic reaction.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A fuel cell catalyst particle, comprising:
a core comprising a material that is different from platinum; and
a shell on the core, the shell comprising platinum, the shell having a plurality of facets, at least a majority of the facets being {111} facets.

2. The fuel cell catalyst particle of claim 1, wherein all of the facets are {111} facets.

3. The fuel cell catalyst particle of claim 1, wherein the majority of the facets are {111} platinum facets.

4. The fuel cell catalyst particle of claim 1, wherein the shell comprises platinum and at least one transition metal.

5. The fuel cell catalyst particle of claim 4, wherein the transition metal comprises at least one of Ni, Co, Fe, Cr, V, Mn, Cu, Zn, Ti, Zr, Y, W or Ta.

6. The fuel cell catalyst particle of claim 1, wherein the shell comprises platinum and at least one other noble metal.

7. The fuel cell catalyst particle of claim 6, wherein the other noble metal comprises at least one of Ru, Rh, Pd, Ag, Re, Os, Ir or Au.

8. The fuel cell catalyst particle of claim 1, wherein the shell has an octahedral shape.

9. The fuel cell catalyst particle of claim 1, wherein the shell has a tetrahedral shape.

10. The fuel cell catalyst particle of claim 1, wherein the core comprises at least one noble metal.

11. The fuel cell catalyst particle of claim 10, wherein the noble metal comprises at least one of Ru, Rh, Pd, Ag, Re, Os, Ir or Au.

12. The fuel cell catalyst particle of claim 1, wherein the core comprises a palladium alloy.

13. The fuel cell catalyst particle of claim 1, wherein the core comprises at least one of a carbide, a metal oxide or a polymer.

14. A fuel cell, comprising:
a membrane;
a first catalyst layer on one side of the membrane; and
a second catalyst layer on an opposite side of the membrane,
wherein at least one of the catalyst layers comprises a plurality of particles each having a core comprising a material that is different from platinum and a shell on the core, the shell comprising platinum, the shell having a plurality of facets, at least a majority of the facets being {111} facets.

15. The fuel cell of claim 14, wherein all of the facets are {111} facets.

16. The fuel cell of claim 14, wherein the majority of the facets are {111} platinum facets.

17. The fuel cell of claim 14, wherein the majority of the {111} facets are platinum alloy {111} facets.

18. The fuel cell of claim 14, wherein the shell has an octahedral shape.

19. The fuel cell of claim 14, wherein the shell has a tetrahedral shape.

20. The fuel cell of claim 14, wherein the core comprises at least one noble metal.

21. The fuel cell catalyst particle of claim 20, wherein the noble metal comprises at least one of Ru, Rh, Pd, Ag, Re, Os, Ir or Au.

22. The fuel cell of claim 14, wherein the core comprises a palladium alloy.

23. The fuel cell of claim 14, wherein the core comprises at least one of a carbide, a metal oxide or a polymer.
